(19) United States
(12) Patent Application Publication
(10) Pub. No.: US 2007/0215367 A1
(43) Pub. Date: Sep. 20, 2007

(54) Cutting edge with trailing wear plate

(76) Inventors: William James Smart, Manjimup (AU); Edward McGugan, Goderich (CA)

Correspondence Address: Ralph A. Dowell of DOWELL & DOWELL P.C., 2111 Eisenhower Ave, Suite 406, Alexandria, VA, 22314, US

(21) Appl. No.: 11/703,800

(22) Filed: Feb. 8, 2007

Related U.S. Application Data
(63) Continuation of application No. PCT/CA05/01256, filed on Aug. 12, 2005.

(30) Foreign Application Priority Data
Aug. 12, 2004 (AU) 2004904521

(51) Int. Cl. A01B 15/00; A01B 23/00

(52) U.S. Cl. 172/695

(57) ABSTRACT

A edge for attaching to a moldboard, having a rearwardly protruding trailing wear plate is disclosed. This device can be manufactured as one piece incorporating the standard edge and additional trailing wear plate or can be in the form of a bolt-on trailing wear plate that would become a component of a standard moldboard edge. The edge is applicable to motor graders, snowploughs or any other machine or attachment that performs similar functions. The trailing wear plate prolongs edge life, reduces grader bounce, enhances grader stability, reduces operator fatigue, allows greater moldboard control, enables greater grading speed and when these factors are combined offer substantial increased efficiency.

### CROSS-REFERENCE TO RELATED APPLICATIONS

This application is a continuation of International PCT Application No. PCT/CA2005/001256 filed on Aug. 12, 2005 which claims priority from Australian Provisional Application No. 2004904521, filed on Aug. 12, 2004, the contents of which are both hereby incorporated by reference.

### TECHNICAL FIELD

The present invention relates generally to moldboards or moldboard assemblies, and in particular, to a edge therefor.

### BACKGROUND OF THE INVENTION

Various utility vehicles or machines are used in the construction and maintenance industries. Of these machines, certain ones are used for moving materials, such as earth, gravel, asphalt, snow, etc. To move these materials, the utility or construction machines typically have a blade, which can push or scrape the material across a working ground surface, pile of material etc. These blades and associated structures are commonly referred to in the industry as moldboards or moldboard assemblies. These machines may include, but are not limited to bulldozers, snowploughs, scrapers, trucks, and motor graders. The following will describe the use of a moldboard with a motor grader. However, it will be appreciated that the same is applicable to other machines that use a moldboard, moldboard assembly, or similar device for moving material.

Motor graders are used to grade a base material such as soil, gravel or sand to provide a generally planar or contoured surface, or a consistent grade to a surface, such as a road bed or road shoulder. The grading may be applied to surfaces directly under the machine as well as down and up slopes, and on either side of the machine. Generally, a motor grader includes a tractor unit (or other suitable construction vehicle) with a moldboard assembly coupled to the front, a side, or below the unit. The tractor unit is typically carried on large rubber tires, and usually has a hydraulic control system for controlling the movements of the moldboard or moldboard assembly and the unit itself. An operator can typically control the moldboard's elevation, tilt, and yaw to orient the lower edge of the moldboard in a desired manner, depending on the nature of the application. Typically, the moldboard assembly includes a moldboard as well as an adjustable mounting assembly for coupling the moldboard to the tractor unit. As the tractor unit moves, the moldboard assembly travels over the ground, so that the lower edge of the moldboard engages the ground for moving material, such as soil, gravel, etc., so as to displace, distribute or level the material. Most moldboard assemblies have two horizontal slide rails secured on longitudinal channel type members, which are typically secured to the rear of the moldboard. These channel members are horizontal, serve to reinforce the moldboard, and typically support the slide rails.

The displacement, etc. of material is accomplished by the accurate positioning and control of the moldboard assembly and moldboard. The moldboard or moldboard assembly is movable relative to a drawbar used to secure the moldboard assembly to the grader frame. The securement of the moldboard or moldboard assembly beneath the grader frame should be designed to avoid wobble or excess clearance in the support arrangement, as poor tolerance variations can significantly affect the operator's control of the moldboard, and the precision that is possible in a grading operation.

Moldboards may also be provided with replaceable edges, typically referred to as cutting or wear edges. The edge can be made of steel with various hardening treatments applied thereto, and may have extra hard alloy inserts installed. The edge is a wearable element that can be replaced more easily and at a lower cost than replacing the entire moldboard. The edges vary considerably in material, heat treatment, thickness and width. These variations are dependent on the particular machine on which the edges are to be installed (e.g. motor grader, bulldozer etc.), the operating conditions of the machine, and the operator or owner's preferences. Many edge designs include a curved cross section so as to match the curve of the moldboard. Other edges are flat in cross section, and some edges consist of replaceable freely rotating bits mounted in a flat or curved steel plate.

U.S. Pat. Nos. 6,813,849 and 5,076,370, the contents of which are incorporated by reference, provide examples of the above.

A typical motor grader provides a very stable configuration in order to maximize the stability and accuracy of the moldboard when in use. Because of this inherent stability, a motor grader can smooth or work a surface at a relatively high speed compared to most other pieces of construction equipment, particularly in light and medium load conditions. A light to medium load condition exists when a relatively small amount of material is being moved by the moldboard, such as during a smoothing or finishing operation, compared to a heavy load condition, wherein a relatively large amount of material is being moved, such as during a scraping or levelling operation. There is, however, an upper speed limit at which the motor grader can effectively operate due to a combination of mechanical effects, which are common to the typical motor grader configuration, and operator factors such as concentration, fatigue, reaction time, etc.

While it can provide stable moldboard positioning, the typical motor grader configuration may exhibit vertical up and down movement (e.g. “bounce”) especially under light to medium load conditions. Motor grader “bounce” can also be aggravated as the travel speed of the motor grader increases. If the travel speed of the motor grader is increased beyond a suitable level, the motor grader will begin to exhibit up and down movement (e.g. begin to bounce). The suitable level or threshold before bounce is experienced varies depending on several conditions, such as, for example, the surface conditions, machine size and load requirements. The bouncing can be aggravated, or may even be initiated, by the edge of the moldboard digging into the road or work surface and causing the moldboard or moldboard assembly, and in turn the motor grader to be displaced vertically downward. This will then produce a reactive force due to the elastic deformation of the motor grader frame and the tires, which may then cause the motor grader to bounce upwards. Since the motor grader moldboard creates a depression in the working surface, which the rear tires will eventually traverse, an additional “bouncing” force can be applied to the motor grader through the rear wheels. Normally this scenario occurs when the motor grader is moving, and thus the motor grader may rapidly begin to “bounce” in a harmonic fashion such that all the forces acting upon the motor grader cause the bouncing to worsen.

Motor grader bounce may cause imperfections or divots, also known as rippling or washboarding, in the road or work surface being graded, which leaves an unacceptable finish. As a result, these imperfections require, in most instances, at least one additional pass to correct. Since a motor grader's primary purpose is to produce a smooth surface, such imperfections are undesirable and are to be avoided. A motor grader is typically operated at a speed at which the “bounce” threshold for any particular grader is not crossed. This “bounce” threshold varies based on vehicle weight, specific configuration, weight distribution, tire size and pressure, road or working surface condition, moldboard length and position etc. In general, such a threshold will not be crossed if the motor grader is driven less than, for example, 6-11 kph, depending on the size of grader and the load conditions. Motor grader manufacturers usually suggest keeping travel speed as high as possible for maximum productivity, but low enough to prevent motor grader bounce.

In addition to keeping the speed of the motor grader below the “bounce” threshold, operators can also tilt the moldboard to carry more material on the moldboard, wherein the gravel, dirt, etc., will provide a dampening effect, allowing an increase in grading speed. Doing so, however, greatly decreases the cutting ability of the moldboard, and the large quantity of material in front of the moldboard requires considerably more power to carry the load. The overall effect allows a slightly increased grading speed, with a considerable increase in power requirements. The downsides of this arrangement include: 1) an increase in fuel consumption by the motor grader; and 2) an accelerated wear of the motor grader drive train and tires.

Grader bounce is inherent in all graders and is a factor inhibiting grader productivity. All grader operators experience this problem and are continuously forced to operate at speeds that are slower than ones which they desire to experience while controlling the grader. These pitfalls are also experienced with other construction machines, such as bulldozers, scrapers and ploughs. Other factors affecting performance include that prior art edges do not allow precise moldboard control, are subject to uncontrolled movements, such as grader bounce, and are generally subject to uneven wear and a short life. They also contribute to an uneven or inconsistent graded surfaces, and can damage road surfaces covered with snow or debris.

It is therefore an object of the present invention to provide a moldboard edge that obviates or mitigates the above-mentioned disadvantages.

### SUMMARY OF INVENTION

To combat the above, a moldboard edge has been developed that addresses the deficiencies noted herein. This edge can be constructed in a number of different configurations and provide the same effect to the motor grader.

In one aspect, the present invention provides a edge for attaching to the bottom edge of a moldboard. The edge has a leading member that has a working surface for moving material, the leading member having an upper end adapted for attachment to the moldboard to orient the working surface towards the forward direction of travel of the moldboard. The edge also has a trailing member protruding rearwardly from a lower end of the leading member and providing a ground engaging surface.

In another aspect, the present invention provides a trailing member for attaching to a moldboard, wherein the moldboard has a replaceable edge attached to a bottom edge thereof. The trailing member has an attachment member for attaching the trailing member to the rear of the moldboard, the attachment member having an attachment end and a lower end. The trailing member also has a ground engaging member attached to the lower end of the attachment member and oriented such that upon attaching the attachment member to the moldboard at the attachment end, a leading end of the ground engaging member is positioned adjacent to the rear of a lower end of the replaceable edge. The ground engaging member provides a ground engaging surface.

In yet another aspect, the present invention provides a moldboard having a concave working surface for moving material, a lower end that has a edge for scraping material from a surface, and a trailing member. The trailing member protrudes rearwardly from the lower end and provides a ground engaging surface.

In yet another aspect, the lower end of the above moldboard is offset rearwardly from the working surface to permit the attachment of a replaceable edge thereto. As a preference, the trailing member has a trailing wear plate attached to its underside, and the lower end has a length less than that of the replaceable edge, such that a downward facing surface of the replaceable edge is contiguous with a ground engaging surface of the trailing wear plate.

### BRIEF DESCRIPTION OF THE DRAWINGS

Various objects, features and attendant advantages of the present invention will become more fully appreciated and better understood when considered in conjunction with the accompanying drawings, in which like reference characters designate the same or similar parts throughout the several views.

FIG. 1 is a pictorial perspective view of a motor grader having a prior art moldboard assembly attached thereto.

FIG. 2 is a side view of the prior art moldboard assembly of FIG. 1.

FIG. 3 is a side view of an embodiment of the present invention.

FIG. 4 is a side view of the embodiment of FIG. 3 in an alternative configuration.

FIG. 5 is a side view of another embodiment of the present invention.

FIG. 6 is a side view of another embodiment of the present invention.

FIG. 7 is a side view of another embodiment of the present invention.

### DETAILED DESCRIPTION OF THE PREFERRED EMBODIMENT

In order that the present invention may be more fully understood, it will now be described, by way of example, with reference to the accompanying drawings in which FIGS. 3 through 7 illustrate embodiments of the present invention.

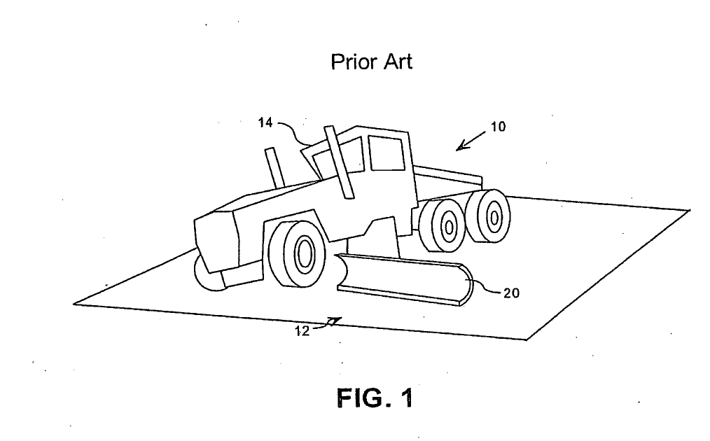

A typical motor grader 10 is shown pictorially in FIG. 1. The motor grader 10 is used herein, by way of example only, to illustrate a typical application of the present invention. The motor grader 10 is used to move material over a surface 12. The motor grader 10 is generally comprised of a tractor unit 14 and a moldboard assembly 20. The moldboard assembly 20 is attached to the tractor unit 14 such that a concave working surface faces the direction of travel of the motor grader 10. The moldboard assembly 20 may be operated by a hydraulic control unit (not shown) to vary its elevation (distance raised from the ground), tilt (angular position displacement about a horizontal axis), and yaw (angular displacement about a vertical axis), as desired.

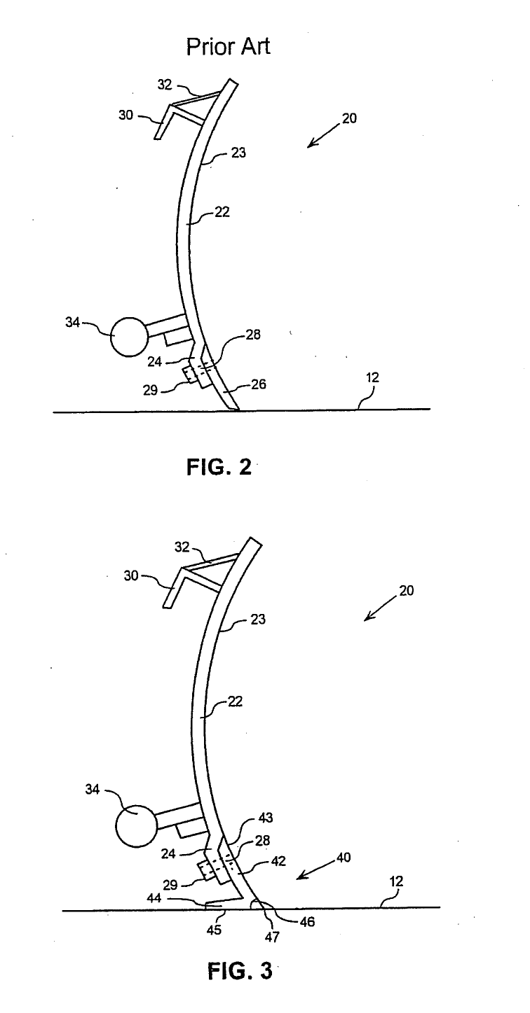

A side view of a prior art moldboard assembly 20 is shown in FIG. 2. The moldboard assembly 20 has a moldboard 22 having a generally concave working surface 23. The lower end of the moldboard 22 terminates at an offset rail 24. The rail 24 has a portion that extends rearwardly a distance that is substantially similar to the thickness of a replaceable edge 26 and a portion that extends downwardly, generally along the direction of the concave working surface 23 of the moldboard 22. It will be understood that the rail 24 may be flat (as shown in FIG. 2) or may follow the curvature of the moldboard 22 (not shown). The rail 24 supports the edge 26, which is attached thereto using a series of retaining bolts 29 fed through a complementary series of holes 28. The holes 28 and bolts 29 are spaced along the rail 24 and edge 26 at any suitable interval. It will be appreciated that the cutting edge 26 may be attached to the moldboard 22 using any suitable means, and bolts 29 and holes 28 are shown for exemplary purposes only.

The moldboard assembly 20 has an upper slide rail 30 supported by a cross member 32 and a lower slide rail 34. The slide rails 30 and 34 are used for attaching the assembly 20 to the tractor unit 14 and for adjusting the position of the moldboard 22. It will be understood, however, that any configuration of slide rails can be used in the attachment of assembly 20 to unit 14. It will also be understood that other moldboard assembly means, known to a person skilled in the relevant art, could be used with the present invention. Examples of such attachment means, are provided in U.S. Pat. Nos. 6,904,978; 6,813,849; and 6,799,640; the contents of which are incorporated herein by reference.

Typically, the moldboard 22 may be ⅞ inch thick, 22 inches wide, and 12 feet long. It will be appreciated, however, that the moldboard 22 will be sized and configured according to its particular application. As such, many possible sizes and configurations for the assembly 20 and particularly the moldboard 22 can be used.

An improved edge 40 in accordance with the present invention is shown in FIG. 3. The edge 40 is adapted to be attached to the moldboard 22 using the bolts 29 and holes 28, in place of the edge 26. Therefore, the edge 40, in this example, would also have a series of corresponding holes 28 that match those in the rail 24.

The edge 40 has a leading member 42 that has a working surface 43 that is generally contiguous with the working surface of the moldboard 22 and terminating at a tip 47. While the member 42 is preferably shaped to conform with the curvature of the moldboard 22, it will be appreciated that the member 42 may also comprise any suitable contour. Working surface 43 of the member 42 is used to scrape and move material over the surface 12. The leading member 42 is capable of performing these tasks in a manner similar to the edge 26 as noted above.

Edge 40 also has a trailing member 44. The trailing member 44 protrudes or extends rearwardly from the leading member 42. Since the trailing member 44 extends from the leading member 42, a ground engaging surface 45 is provided, extending rearwardly from tip 47. The trailing member 44 is preferably a steel plate and preferably protrudes or extends rearwardly from the leading member 42 such that a rearwardly facing angle 46 is formed between the working surface 43 and ground engaging surface 45, each of which terminate at the tip 47. Preferably, this angle varies between approximately 75 and approximately 105 degrees.

The angle 46 of the member 44 with respect to the member 42 depends on the orientation of the moldboard assembly 20. For example, a generally vertical orientation of the moldboard 22 is shown in FIG. 3. The angle of the working surface 43 of the leading member 42 with respect to the ground engaging surface 45 of the trailing member 44, is determined by positioning the top of the moldboard 22 in this vertical position. In this position, the ground engaging surface 45 of the trailing member 44 is angled with respect to the working surface 43 of the leading member 42 in such a way to enable the ground engaging surface 45 of the trailing member 44 to maintain contact with the ground surface 12 along a portion of the length of the ground engaging surface 45, preferably a substantial portion thereof.

It will be understood that this angle may vary depending on the use of the grading machinery. The dimensions of the invention will vary and shall not be limited to having the face of the leading member 42 constructed with dimensions similar to the standard edge 26, and with a similar thickness.

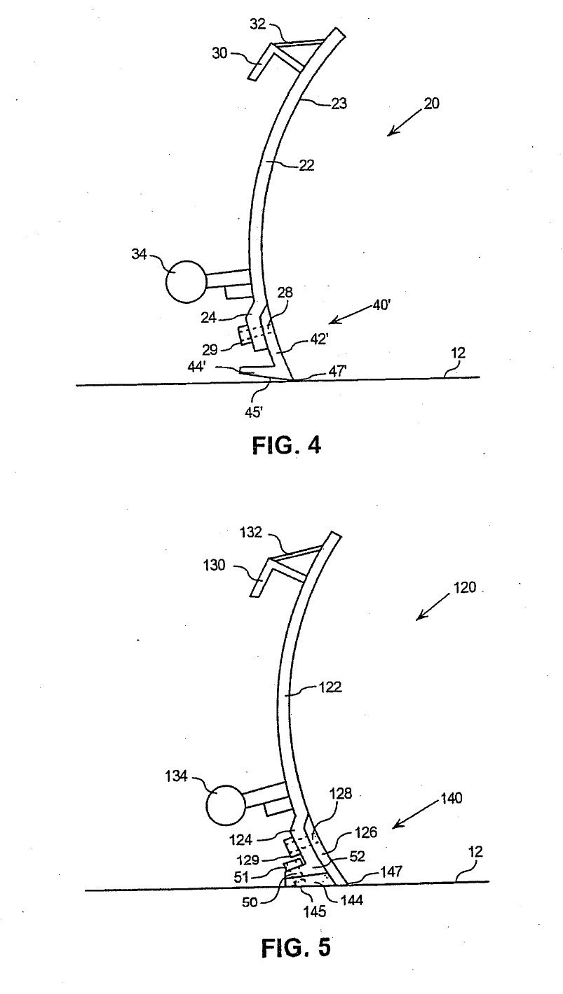

However, it will be appreciated that since the moldboard assembly 20 can be oriented in a number of configurations, the ground engaging surface 45 of the trailing member 44 will not always maintain contact with the ground surface 12 along a substantial portion thereof. Such a configuration is shown in FIG. 4. The configuration in FIG. 4 is desirable for digging into the surface 12, which will be explained in greater detail below.

It will be understood that the trailing member 44 may be any length as desired based on the application of the moldboard. The choice of length of the trailing member 44 may vary depending on the particular application, surface conditions, etc.

Trailing member 44 helps to reduce grader bounce. With the embodiment shown in FIG. 3, grader bounce can be greatly reduced or even eliminated, and material can be moved at speeds up to 25 kph, depending on load conditions, etc. The increased stability of the moldboard assembly 20 as a result of trailing member 44 is greatly improved, and the concentration required while operating the grader 10 can be reduced.

The trailing member 44 shown in FIG. 3, can be constructed of known materials for use in constructions of edges, such as, for example, cutting or wear edges. The thickness of the trailing member 44 will vary depending on the application. Its thickness would preferably be between approximately 15 mm and approximately 60 mm. An edge is preferably approximately 16 mm thick with an effective working thickness (i.e. a minimum thickness permitting operability) of approximately 10 mm. The trailing member 44 would start to bend, however, when worn to a thickness of approximately 5 mm. A thickness of greater than approximately 50 mm could be anticipated or used in heavy applications.

The length of the ground engaging surface provided by the edge 40 will also vary depending on application. For example, for general road maintenance, a length of approximately 150 mm would be appropriate, and preferably, the length of the ground engaging surface is in the range of approximately 50 mm to approximately 200 mm.

Referring to FIG. 4, hard material can be cut by tilting the moldboard 22 forward relative to the generally vertical position shown in FIG. 3, allowing the tip 47′ of the leading member 42′ to easily penetrate harder material. Loose and soft material can be graded using the moldboard 22 in the generally vertical position (i.e. that shown in FIG. 3) to eliminate bounce. When cutting, grader bounce is usually not a problem as the machine is usually under a greater load and operating at a slower speed. Typically, grading applications result in a ratio of approximately 25% of operating time designated to cutting material (such as shown in FIG. 4) and approximately 75% of operating time designated to light to medium grading of loose or soft material (such as shown in FIG. 3). It will be understood that such ratios will vary depending on the nature of the application. With this typical ratio, it will be understood that with the presence of trailing member 44, the tip 47 of the leading member 42 will more easily self sharpen during grading operation and as such will be able to penetrate harder material more easily than a conventional edge 26, which is not self sharpened.

Most construction applications involve grading loose or soft materials. Therefore, the moldboard 22 is most typically positioned in the generally vertical position shown in FIG. 3. Maintenance grading, especially dry grading corrugations, involves grading loose material, in which case the moldboard 22 would also be positioned in this position. Dry grading with the edge 40 at increased speeds has the added benefit of throwing loose material from the moldboard 22 at a distance equivalent to a longer moldboard travelling at a slower speed.

Another embodiment of the present invention is shown in FIG. 5. In this embodiment, the assembly 120 has a modified moldboard 122. Elements similar to those shown in FIG. 3 are given like numerals with the prefix “I”. In this embodiment, a modified edge 140 is provided, wherein a trailing foot 52 extends rearwardly from the lower end of the rail 124. A standard replaceable cutting edge 26 can be affixed to the rail 124 using similar bolts 29 and holes 28 as before. The vertical length of the downward portion of rail 124 may be less than the length of the edge 26, such that when the cutting end of the edge 26 rests on the surface 12, the lower edge of foot 52 is offset from the tip 147 of edge 26, and does not engage with the surface 12.

A replaceable, wearable trailing member 144 can thus be affixed under the foot 52 to provide a ground engaging surface 145 that is substantially contiguous with the ground engaging surface 126 of the edge 26. The trailing member 144 is affixed to the foot 52 using a set of bolts 51 and holes 50. The bolts 51 and holes 50 are suitably spaced along the foot 52 similar to the bolts 29 and holes 28, as desired.

In the embodiment shown in FIG. 5, the modified moldboard 122 enables replaceable members (i.e. 26 and 144) to be discarded and replaced as needed during operation of the motor grader 10. This prolongs the life of the moldboard 122 whilst providing the benefits of having a trailing member 144, i.e. to inhibit motor grader bounce.

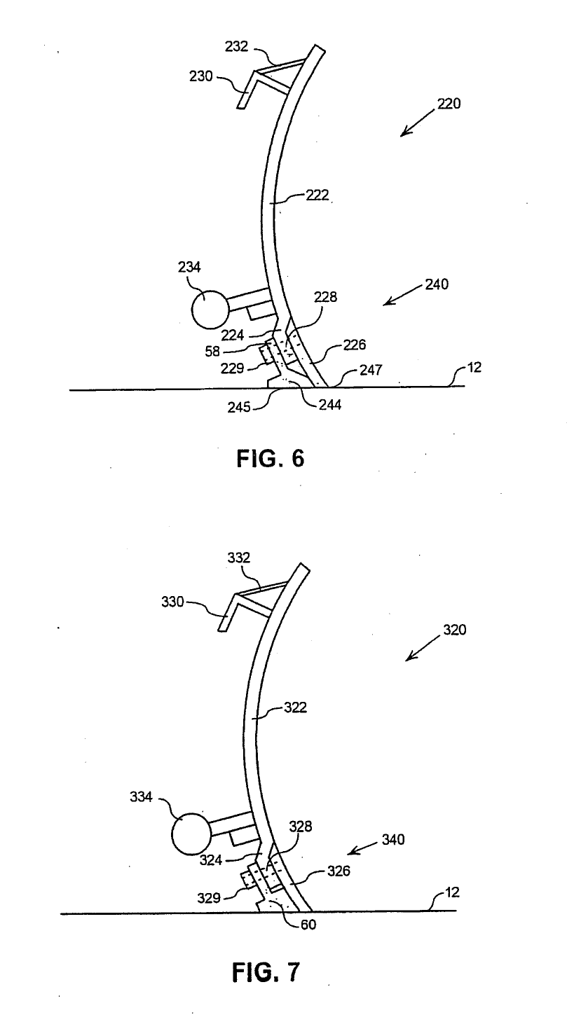

A further configuration is shown in FIG. 6, where an attachment member is attached to the back of the moldboard 222, in this case, a bar 58. Elements similar to those shown in FIG. 3 are given like numerals with the prefix “2”. At the lower end of the bar 58 is a modified trailing member 244. As shown in FIG. 6, the trailing member 244 is arranged in such a manner to have a ground engaging surface 245 that would be in flat contact with the working surface 12 when the moldboard assembly 220 is in it's working position (i.e. as shown in FIG. 6). A standard edge 26 could be bolted to the front of the moldboard 222. The edge 26 and the bar 58 would be affixed to the moldboard 222 using a similar series of bolts 29 and holes 28. The resulting combination would provide both the normal front wear surface of the edge 26, and the horizontal trailing edge 244 which inhibits motor grader bounce.

A further configuration is shown in FIG. 7, implemented on a snow wing. Elements similar to those shown in FIG. 3 are given like numerals with the prefix “3”.

A snow wing is an attachment for a motor grader that extends to one side of the machine, and is designed to displace the material being moved far back from the road surface to eliminate snow build-up and facilitate continued snow displacement. A snow wing is described in U.S. Pat. No. 5,177,887, the contents of which are incorporated herein by reference.

In this embodiment, a series of snow wing shoes 60 would be bolted to the rear of the moldboard 322 in a manner similar to before, using a series of bolts 29 and holes 28. Snow wing shoes 60, typically equipped with steel or cast iron, are provided on the back of the wing edge to prevent the wing from digging into a soft surface or from contacting a hard wearing surface such as a road, which may cause damage to the road surface. A continuous series of these shoes 60 located across the back of the moldboard 22, would again provide the surface area necessary to inhibit motor grader bounce. The shoes 60 can be spaced as necessary, depending on the configuration of the motor grader 10, the operating conditions, and operator or owner preference etc. A continuous row may be placed with no gaps between the shoes 60 or a row with gaps of varying width may be installed as desired.

Therefore, it has been shown that a number of different configurations of trailing members may be used with a motor grader 10 to prevent bounce, and improve machine productivity. These include both one piece (e.g. 40) or multiple piece edge assemblies (e.g. 140 or 240); used with standard replaceable edges 26 or providing an integral cutting edge (e.g. 42); or using a series of shoes 60.

It will be appreciated that the present invention may also be used to increase the performance of other machines, such as but not limited to, bulldozers and scrapers.

The operation of the present invention will be discussed generally in reference to FIG. 3. In light to medium load operating conditions, the downwardly facing ground engaging surface 45 of the generally horizontal trailing member 44 of edge 40 shown in FIG. 3, would preferably be in full contact with the road or working surface. For clarity, the following description, which is applicable to all possible embodiments of the present invention, will make reference primarily to the embodiment shown in FIG. 3. However, it will be understood that the other embodiments noted above, may also be used as noted below.

While the generally horizontal trailing member 44 of edge 40 can be generally parallel with the work surface, it will be understood that depending on the angle at which the moldboard 22 is positioned relative to the work surface 12, or the configuration of the trailing member 44, the trailing member 44 can be angled relative to the working surface 12 so that at least a portion of trailing member 44 is in contact with the working surface 12, such as the configuration shown in FIG. 4. Such an angle may be used when the leading edge of the leading member 42 is used to dig into the surface 12. Typically, the moldboard 22 would be in a generally vertical position. In other words, a line connecting the upper end of the moldboard 22 with the lower end of the leading member 42 will be generally perpendicular to the working surface 12, as shown in FIG. 3.

It will be understood, however, that the moldboard 22 may be used in a position wherein the assembly 20 may be angled relative to the direction of travel of the motor grader 10, i.e., rotated about a vertical axis.

During operation, the trailing member 44 acts as a stabilizer of the moldboard assembly 20 to reduce grader bounce. When the grader 10 is grading a surface 12 at a speed that would normally cause the motor grader 10 to bounce (e.g. typically greater than 6-11 kph depending on the size of the machine etc.), at least a portion of ground engaging surface 45 of the trailing member 44 is in contact with the working surface 12 such that a sufficient amount of the surface area of the trailing member 44 prevents the tip 47 of the leading member 42 from digging into the working surface.

When the tip 47 cannot dig into the working surface 12, the normal bouncing sequence cannot commence. Since bouncing cannot be initiated, the speed at which the motor grader 10 can operate can be increased. The speed of the grader can be increased up to 2 to 3 times the speed normally associated with grading. In most cases the speed can be increased up to the limit of the power available to the motor grader drivetrain.

As noted above, the moldboard 22 is in a substantially vertical position, which typically allows the gravel or dirt carried in front of the moldboard 22 to roll and tumble freely, thus increasing the efficiency of the movement of material, and contributing to improved overall machine efficiency.

As noted previously, the increased speed at which the machine 10 can grade material will dramatically improve the productivity of the motor grader 10, and improve the condition of the surface 12 being graded, by substantially eliminating the washboarding effect caused by motor grader bounce.

In addition, the use of a trailing member 44 can be used on construction machines of different configurations than motor graders 10. Any machine that utilizes a ground engaging surface or edge can become unstable at a given speed or condition and would benefit from the use of such a trailing member 44. Machines such as bulldozers and scrapers would fit into this category.

A further benefit is that the edge has substantially more material in contact with the working surface, thus reducing the rate of edge wear. Since standard grader moldboard edges 26 may wear out in as little as 2 days in many conditions, the increased quantity of material in the improved edges (e.g. 40, 140, 240, 340, 60, and 72) will result in a situation where, for a given condition or operating mode that will yield a consistent material wear rate, the edges may now last for up to six times longer. In the example above, the edges will typically last up to twelve days instead of two.

As noted above with respect to FIG. 4, the motor grader 10 is sometimes used to cut down into the working surface 12, such as in road construction or heavy material removal and may be referred to as a “cutting mode”. The motor grader 10 in such cases generally operate at low speeds due to the heavy load of material on the working surface of the moldboard 22 where motor grader bounce is not a concern. In these situations, the improved edge (e.g. 40′) allows the moldboard 22 to be tilted forward slightly, where the trailing member 44′ is lifted off the working surface 12, as shown in FIG. 4. The angle between the trailing member 44′ and the surface 12 is dependent how deep the operator of the motor grader 10 wishes to dig.

The sharp point 47′ of the leading member 42′ is then in contact with the working surface 12, and due to the dramatically reduced contact area, the edge will cut into the surface 12 much more readily, and behave in a manner similar to a standard moldboard edge 26 as shown in FIG. 2.

The operator has the flexibility to operate the motor grader 10 in both surface grading and cutting modes with the same edges (e.g. 40) installed and needs only adjust the tilt of the moldboard 22 which is commonly done by operators anyway.

Aspects of this invention have been shown, in various testing, to increase the productivity of the motor grader 10 in excess of 100% through enabling an increased grading speed. It appears that carbide inserts may be an option in preserving the cutting edge tip, especially when working hard abrasive materials for extended periods. Hardfacing (i.e. the application of materials having superior hardness to a substrate) and or carbide inserts may also allow the trailing member 44 to be constructed of thinner, lighter material, enabling easier attachment and removal.

The present invention may also reduce the likelihood of having the tip 47 cut into the underlying surface, when used with a snow plow. This enables the snow plow to be operated at greater speeds due to the reduction in grader bounce. It could be used with all types of snow plowing equipment.

By adding a trailing member (e.g. 44) to the bottom of the standard edge the surface area of the edge contacting the ground is greatly increased making depth and applied pressure control more accurate. The downward pressure on the increased surface area provided by the trailing member of the present invention results in less wear and increased edge life due to the pressure being spread out over a wider surface area than prior art edges.

The profiles of the present invention have widths that are specified by manufacturers, and typically each moldboard 22 would have two or more widths bolted to them similar to current standard edges 26. To enable penetration in hard surfaces, the moldboard 22 is simply tilted forward to allow the cutting edge tip to easily penetrate the surface as in FIG. 4 until the required depth of cut is appropriate. The moldboard 22 is then rolled back to the position shown in FIG. 3.

This invention would ideally be manufactured as a long rolled and profiled length at a steel mill, and then cut and drilled to the particular manufacturer's specifications. Alternatively, welding the trailing member 44 to edges 26 is an option and, used edges 26 may also be recycled as a wear plate 44.

Different applications may warrant different specifications depending on materials being graded e.g. salt, snow, gravel sand or any other material.

Hardfacing, carbide inserts or other counter wear treatments, such as those noted above, can be performed on the trailing members, leading members or standard edges 26 to increase durability, depending on the application.

Although the present invention has been described according to certain specific embodiments, it will be appreciated that various modifications thereof will be apparent to a person skilled in the art without departing from the scope of the invention as outlined in the claims appended hereto.

What is claimed is:

1. An edge for a moldboard comprising:
a first member having an attachment end for attaching the edge to the moldboard, a ground engaging end having a first ground engaging surface, and a working surface extending between the attachment end and the ground engaging end; and
a second member extending rearwardly from the first member, the second member having a forward end adjacent the ground engaging end, a rear end spaced rearwardly from the forward end and a second ground engaging surface extending between the forward end and the rear end;
wherein the first and second ground engaging surfaces are substantially flush.

2. The edge of claim 1 wherein the first and second member are integrally formed.

3. The edge of claim 1 wherein the moldboard comprises a rail member extending from a lower portion thereof and one of the first or second members are adapted for attachment to the rail member.

4. The edge of claim 2 wherein the moldboard comprises a rail member extending from a lower portion thereof and the first member is adapted for attachment to the rail member.

5. The edge of claim 3 wherein the rail has an upper and lower portion and the second member is adapted for attachment to the lower portion and the first member is adapted for attachment to the upper portion.

6. The edge of claim 5 wherein the upper portion of the rail is rearwardly offset to accommodate the first member of the edge and when the first member is attached to the upper portion of the rail member, the working surface of the first member is substantially flush with a working surface of the moldboard.

7. The edge of claim 3 wherein the first and second members are adapted for attachment to an upper portion of the rail member.

8. The edge of claim 1 wherein an angle formed by the working surface of the first member and the second ground engaging surface is between approximately 75 degrees and approximately 105 degrees.

9. The edge of claim 1 wherein the attachment end of the first member comprises a plurality of holes to enable the edge to be bolted to the moldboard using a plurality of corresponding bolts.

10. The edge of claim 1 wherein the second member has a maximum thickness, measured upwardly from the ground engaging surface, in the range of approximately 15 mm to approximately 60 mm.

11. The edge of claim 10 wherein the thickness is approximately 16 mm.

12. The edge of claim 1 wherein a rearwardly extending dimension of the second ground engaging surface is in the range of approximately 50 mm to approximately 200 mm.

13. The edge of claim 12 wherein the dimension is approximately 150 mm.

14. The edge of claim 1 wherein the thickness of the second member tapers rearwardly from the first member.

15. The edge of claim 1 wherein the edge is a cutting edge.

16. The edge of claim 1 wherein the moldboard is a snow wing.

17. A moldboard comprising the edge of claim 1.

18. A trailing member for attaching to a moldboard having an edge with a first ground engaging surface, the trailing member comprising:
an attachment portion for attaching the trailing member to the moldboard; and
a ground engaging portion comprising:
a forward end adjacent the edge;
a rear end spaced rearwardly from the forward end; and
a second ground engaging surface extending between the forward end and the rear end;
wherein upon attachment of the trailing member to the moldboard, the first and second ground engaging surfaces are substantially flush.

19. The trailing member of claim 18 wherein the moldboard comprises a rail member extending from a lower portion thereof and the attachment portion is adapted for attachment to the rail member.

20. The trailing member of claim 19 wherein the rail has an upper portion and a generally L-shaped lower portion extending rearwardly from the moldboard, and the attachment portion of the trailing member is adapted for attachment to the lower portion of the rail.

21. The trailing member of claim 18 wherein the attachment portion comprises a plurality of holes to enable the trailing member to be bolted to the rear of the moldboard using a plurality of corresponding bolts.

22. The trailing member of claim 18 wherein the ground engaging portion has a maximum thickness, measured upwardly from the second ground engaging surface, in the range of approximately 15 mm to approximately 60 mm.

23. The trailing member of claim 22 wherein the thickness is approximately 50 mm.

24. The trailing member of claim 18 wherein the combined measurement of the first and second ground engaging surfaces is in the range of approximately 50 mm to approximately 200 mm.

25. The trailing member of claim 24 wherein the measurement is approximately 150 mm.

26. The trailing member of claim 18 wherein the thickness of the ground engaging portion tapers rearwardly.

27. A moldboard comprising the trailing member of claim 18.

28. A moldboard comprising:
a concave working surface for moving material;
a lower end having a edge for scraping material from a surface, the edge having a first ground engaging surface; and
a trailing member comprising:
a forward end adjacent the edge;
a rear end spaced rearwardly from the forward end; and
a second ground engaging surface extending between the forward end and the rear end;
wherein the first and second ground engaging surfaces are substantially flush.

29. The moldboard of claim 28 wherein the trailing member has a maximum thickness, measured upwardly from the second ground engaging surface, in the range of approximately 15 mm to approximately 60 mm.

30. The moldboard of claim 29 wherein the thickness is approximately 50 mm.

31. The moldboard of claim 28 wherein the rearwardly extending dimension of the second ground engaging surface is in the range of approximately 50 mm to approximately 200 mm.

32. The moldboard of claim 31 wherein the dimension is approximately 150 mm.

33. The moldboard of claim 28 wherein the lower end is offset rearwardly from the working surface to permit the attachment of a replaceable edge thereto.

34. The moldboard of claim 33 wherein the trailing member has a trailing wear plate attached to its underside, and the lower end has a length less than that of the replaceable edge, such that a downward facing surface of the replaceable edge is flush with a ground engaging surface of the trailing wear plate.

35. The moldboard of claim 34 wherein the trailing wear plate has a maximum thickness in the range of approximately 15 mm to approximately 60 mm.

36. The moldboard of claim 35 wherein the thickness is approximately 16 mm.

37. The moldboard of claim 34 wherein the rearwardly extending dimension of the ground engaging surface of the trailing wear plate is in the range of approximately 50 mm to approximately 200 mm.

38. The moldboard of claim 37 wherein the dimension is approximately 150 mm.

39. The moldboard of claim 34 wherein the trailing member and the trailing wear plate each have a plurality of corresponding holes to enable the trailing wear plate to be bolted to the trailing member using a plurality of corresponding bolts.

40. The moldboard of claim 28 wherein the thickness of the trailing member tapers rearwardly from the lower end.

41. The moldboard of claim 34 wherein the thickness of the trailing wear plate tapers rearwardly from the lower end.
